(19) United States
(12) Patent Application Publication
(10) Pub. No.: US 2022/0340278 A1
(43) Pub. Date: Oct. 27, 2022

(54) METHOD OF SPRAYING A FIELD WITH AN UNMANNED AERIAL VEHICLE

(71) Applicant: BAYER AKTIENGESELLSCHAFT, Leverkusen (DE)

(72) Inventors: Malcolm FAERS, Düsseldorf (DE); Andrew Charles CHAPPLE, Langenfeld (DE)

(21) Appl. No.: 17/634,854

(22) PCT Filed: Aug. 10, 2020
(86) PCT No.: PCT/EP2020/072340

§ 371 Date: Feb. 11, 2022

(30) Foreign Application Priority Data
Aug. 15, 2019 (EP) 19191884.6

(51) Int. Cl. B64D 1/18; B64C 39/02; B64C 3/56

(52) U.S. Cl. CPC B64D 1/18; B64C 39/02; B64C 3/56; B64C 2201/12

(57) ABSTRACT

The present invention relates to method of spraying a field with an unmanned aerial vehicle (UAV). The method comprises: flying an UAV over a crop within a field and spraying the crop with a liquid spray, wherein the UAV comprises a wing extending in directions perpendicular to a fore-aft axis of the UAV, wherein the wing has a span extending from one side of the fore-aft axis to the other side of the fore-aft axis, and wherein spraying the crop comprises spraying substantially all of the crop at a height of the wing above the crop that is less a length of the span of the wing.

### FIELD OF THE INVENTION

The present invention relates to a method of spraying a field with an unmanned aerial vehicle (UAV), and to a UAV that can carry out that method.

### BACKGROUND OF THE INVENTION

The general background of this invention is the application of herbicides and pesticides to crops.

Current single or multi-rotor UAVs can achieve penetration of the spray into the base of the crop canopy by the down draught from the rotors. This places a limitation on the width of the spray swath, since this is governed by the width of the rotor on a single rotor UAV and by the distance between the outermost rotors on a multi-rotor UAV. The width of the spray swath is important to maximise since this governs the work-rate of the UAV; a higher work-rate allows a greater area to be sprayed in the same time. To increase the width of the spray swath requires an increase in the length of the rotors on a single-rotor UAV and in increase in the distance between the outermost rotors on a multi-rotor UAV. This has the disadvantage that the size of the UAV increases making it more difficult to transport and requiring more power to operate. For the multi-rotor UAV additional rotors may also be required between the outermost rotors to ensure even penetration into the crop canopy across the spray swath.

Hence, there is a need for a way to increase the spray swath width to increase the work-rate without increasing the size of the UAV, and also without increasing the power requirements of the UAV.

### SUMMARY OF THE INVENTION

It would be advantageous to have improved means for spraying a field with an unmanned aerial vehicle spraying liquids such as those containing fertilizers, herbicides and pesticides, such as insecticides and fungicides.

The object of the present invention is solved with the subject matter of the independent claims, wherein further embodiments are incorporated in the dependent claims. It should be noted that the following described aspects and examples of the invention apply also for the method of spraying a field with an unmanned aerial vehicle and for the unmanned aerial vehicle configured to carry out the method.

In a first aspect, there is provided a method of spraying a field with an unmanned aerial vehicle (UAV). The method comprises flying an UAV over a crop within a field and spraying the crop with a liquid spray. The UAV comprises a wing extending in directions perpendicular to a fore-aft axis of the UAV, and the wing has a span extending from one side of the fore-aft axis to the other side of the fore-aft axis. Spraying the crop comprises spraying substantially all of the crop at a height of the wing above the crop that is less a length of the span of the wing.

The term wing here can mean an aerofoil, in that the wing or aerofoil can provide all the lift required for the UAV, in that the lift provided by the wing or aerofoil can equal the weight of the UAV. However, the wing or aerofoil can also provide only a part of the lift required for the UAV, in that the lift provided by the wing or aerofoil can be less the weight of the UAV. Thus, in this second case additional lift can be provided by one or more sets of rotor blades.

In an example, the spraying the crop with the liquid spray is carried out by a plurality of spray units extending in the directions perpendicular to the fore-aft axis of the UAV.

In an example, the plurality of spray units are spaced along a span equivalent to the span of the wing.

In an example, two spray units of the plurality of spray units are separated one from the other by a distance substantially equivalent to the length of the span.

In an example, the height at which substantially all of the crop is sprayed is less than half the length of the span.

In an example, the wing is extendible.

In an example, the wing is extendible via a folding mechanism.

In an example, on either side of the fore-aft axis of the UAV a first part of the wing is configured to fold over a second part of the wing, wherein the second part of the wing is attached to a body of the UAV.

In an example, the plurality of spray units are mounted on a boom separate to the wing.

In an example, the boom is located below a plane of the wing.

In an example, the boom is located in front of the wing with respect to a forward flight direction of the UAV.

In an example, the boom is extendible.

In an example, the wing is extendible via a folding mechanism.

In an example, on either side of the fore-aft axis of the UAV a first part of the boom is configured to fold over a second part of the boom, and the second part of the boom is attached to a body of the UAV.

In an example, the plurality of spray units are housed within and/or attached to a second wing separate to the wing wherein the second wing is configured to atomize the liquid from the plurality of spray units by using the airflow from the wing.

The term “second wing” refers to a wing or an aerofoil that can atomise the liquid into fine droplets by use of the airflow from the wing during flight.

In an example, the second wing is located below a plane of the wing.

In an example, the at least one plane of the second wing is located substantially parallel to at least one plane of the wing.

In an example, the UAV comprises at least one first actuator and at least one second actuator, wherein the at least one first actuator is configured to move the second wing in a vertical direction relative to the wing and wherein the at least one second actuator is configured to move the second wing in a horizontal direction relative to the wing, and wherein the processing unit of the UAV is configured to control the first and second actuator.

In this manner, the droplet size of the liquid from the plurality of spray units can be continuously adjusted by modification of the position of the second wing relative to the wing.

In an example, the UAV comprises at least one rotator actuator configured to rotate the second wing by at least one angle of rotation with respect to the horizontal axis which is perpendicular to the fore-aft axis of the UAV, wherein the processing unit is configured to control the at least one rotator actuator.

In this manner, further adjustment possibilities are provided to control the droplet size.

In an example, the UAV comprises at least one sensor configured to measure a speed of the UAV relative to the ground and at least one additional sensor configured to measure an air movement speed relative to the UAV, wherein, the processing unit of the UAV is configured to determine an air movement direction relative to the ground and determine an air movement speed relative to the ground, the determination comprising utilisation of the speed of the UAV, the air movement direction relative to the UAV and the air movement speed relative to the UAV; and wherein, the processing unit of the UAV is configured to control the at least one first actuator, the at least one second actuator and/or the at least one rotation actuator; the control comprising utilisation of the determined air movement direction relative to the ground and the determined air movement speed relative to the ground.

In this manner, e.g. drift issues due to changing wind conditions can be taken into account e.g. by changing the droplet size of the sprayed liquid by adjusting the position of the second wing relative to the wing.

In an example, the plurality of spray units are located on the upper plane of the second wing in proximity to the leading edge of the second wing.

In an example, the surface of the second wing between the apertures of the plurality of spray units and the trailing edge does comprise a first surface configured to exhibit a first level of adhesion to the liquid and a second surface adjacent to the first surface configured to exhibit a second level of adhesion to the liquid, and wherein the first level of adhesion is less than the second level of adhesion.

In this manner, the control of the droplet spectra is provided through changing how the liquid interacts with the surface of the second wing as it transits across that surface. This leads to an ability to further control the way the liquid breaks up either on the surface or at the trailing edge of the second wing.

In an example, the second wing is extendible.

In an example, the second wing is extendible via a folding mechanism.

In an example, on either side of the fore-aft axis of the UAV a first part of the second wing is configured to fold over a second part of the second wing, and the second part of the second wing is attached to a body of the UAV.

In an example, spraying substantially all of the crop at a height of the wing above the crop comprises spraying a first swath and spraying a second swath in an opposite direction, wherein a region of unsprayed crop separates the first swath from the second swath.

In an example, spraying substantially all of the crop at a height of the wing above the crop comprises spraying a subsequent swath between the first swath and the second swath.

In a second aspect, there is provided a UAV configured to carry out the method of the first aspect.

Advantageously, the benefits provided by any of the above aspects equally apply to all of the other aspects and vice versa.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic example of a methodology of spraying a field using the new technique on the left as opposed to an existing way of spraying a field on the right;

FIG. 2 shows a schematic example of spraying in a normal manner at the top without ground effect and shows a schematic example of spraying in the new manner described here at the bottom with ground effect;

FIG. 3 shows crop canopy penetration of the sprayed chemical with and without ground effect; and

FIG. 4 shows schematic representations of an exemplar UAV with folded wings and booms and with extended wings and booms.

FIG. 5 shows a schematic representation of an exemplar UAV with wings and a second wing.

FIG. 6 shows a schematic example of how the second wing can be adjusted relative to the wing from a side view perspective.

FIG. 7 shows a schematic example of the influence of the airflow from the wing on the liquid atomization process on the upper part of the second wing from a side view perspective.

FIG. 8 shows a schematic example of the second wing with a plurality of spray units from a top view perspective.

### DETAILED DESCRIPTION OF EMBODIMENTS

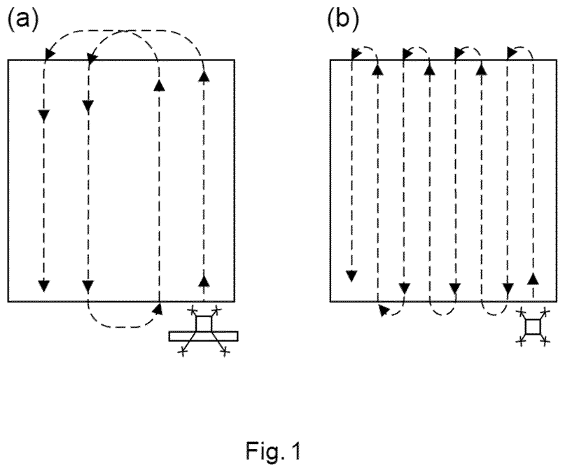

FIGS. 1-8 relate to a method of spraying a field with an unmanned aerial vehicle (UAV), and to a UAV that can carry out that method. According to an example a method of spraying a field with an unmanned aerial vehicle (UAV) comprises flying an UAV over a crop within a field and spraying the crop with a liquid spray. The UAV comprises a wing extending in directions perpendicular to a fore-aft axis of the UAV, and the wing has a span extending from one side of the fore-aft axis to the other side of the fore-aft axis. The spraying the crop comprises spraying substantially all of the crop at a height of the wing above the crop that is less a length of the span of the wing.

According to an example, the spraying the crop with the liquid spray is carried out by a plurality of spray units extending in the directions perpendicular to the fore-aft axis of the UAV.

According to an example, the plurality of spray units are spaced along a span equivalent to the span of the wing.

According to an example, two spray units of the plurality of spray units are separated one from the other by a distance substantially equivalent to the length of the span.

According to an example, the height at which substantially all of the crop is sprayed is less than half the length of the span.

In an example, the height at which substantially all of the crop is sprayed is less than a third of the length of the span.

In an example, the height at which substantially all of the crop is sprayed is less than a quarter of the length of the span.

According to an example, the wing is extendible.

According to an example, the wing is extendible via a folding mechanism.

According to an example, on either side of the fore-aft axis of the UAV a first part of the wing is configured to fold over a second part of the wing. The second part of the wing is attached to a body of the UAV.

In an example, first and second parts of the wing have associated centre axes, and wherein in an un-deployed configuration an angle between the centre axes and the fore-aft axis of the UAV is less than an angle between the centre axes and the fore-aft axis of the UAV in a deployed configuration.

In an example, in the deployed configuration the first and second parts of the wing in the deployed configuration extend on opposite sides of the fore-aft axis of the UAV.

According to an example, the plurality of spray units are mounted on a boom separate to the wing.

According to an example, the boom is located below a plane of the wing.

According to an example, the boom is located in front of the wing with respect to a forward flight direction of the UAV.

According to an example, the boom is extendible.

In an example, the boom is extendible via a folding mechanism.

In an example, on either side of the fore-aft axis of the UAV a first part of the boom is configured to under over a second part of the boom, wherein the second part of the boom is attached to a body of the UAV.

In an example, first and second parts of the boom have associated centre axes, and wherein in an un-deployed configuration an angle between the centre axes and the fore-aft axis of the UAV is less than an angle between the centre axes and the fore-aft axis of the UAV in a deployed configuration.

In an example, in the deployed configuration the first and second parts of the boom in the deployed configuration extend on opposite sides of the fore-aft axis of the UAV.

According to an example, the plurality of spray units are housed within and/or attached to a second wing separate to the wing wherein the second wing is configured to atomize the liquid from the plurality of spray units by using the airflow from the wing.

According to an example, the second wing is located below a plane of the wing.

In an example, the second wing extends in directions perpendicular to a fore-aft axis of the UAV, and the second wing has a span extending from one side of the fore-aft axis to the other side of the fore-aft axis.

In an example, the wing extends beyond the second wing. In this manner, off-target spray from vortices at the tips of the second wing can be avoided.

In an example, the spray liquid is delivered to the plurality of spray units by a plurality of dosing pumps connected to tubes to deliver the spray liquid to defined points along the second wing. These delivery tubes can be contained inside the wing.

According to an example, the at least one plane of the second wing is located substantially parallel to at least one plane of the wing.

According to an example, the UAV comprises at least one first actuator and at least one second actuator, wherein the at least one first actuator is configured to move the second wing in a vertical direction relative to the wing and wherein the at least one second actuator is configured to move the second wing in a horizontal direction relative to the wing, and wherein the processing unit of the UAV is configured to control the first and second actuator.

According to an example, the UAV comprises at least one rotator actuator configured to rotate the second wing by at least one angle of rotation with respect to the horizontal axis which is perpendicular to the fore-aft axis of the UAV, wherein the processing unit is configured to control the at least one rotator actuator.

According to an example, the UAV comprises at least one sensor configured to measure a speed of the UAV relative to the ground and at least one additional sensor configured to measure an air movement speed relative to the UAV, wherein, the processing unit of the UAV is configured to determine an air movement direction relative to the ground and determine an air movement speed relative to the ground, the determination comprising utilisation of the speed of the UAV, the air movement direction relative to the UAV and the air movement speed relative to the UAV; and wherein, the processing unit of the UAV is configured to control the at least one first actuator, the at least one second actuator and/or the at least one rotation actuator; the control comprising utilisation of the determined air movement direction relative to the ground and the determined air movement speed relative to the ground.

In an example, the at least one sensor configured to measure a speed of the UAV relative to the ground comprises a GPS system.

In an example, the at least one sensor configured to measure a speed of the UAV relative to the ground comprises a laser reflectance based system.

In an example, the at least one sensor configured to measure a speed of the UAV relative to the ground comprises a system linked to the transmission of the UAV.

In an example, the at least one sensor configured to measure an air movement direction relative to the UAV comprises a wind vane.

In an example, the at least one sensor configured to measure an air movement speed relative to the UAV comprises an anemometer.

According to an example, the plurality of spray units are located on the upper plane of the second wing in proximity to the leading edge of the second wing.

According to an example, the surface of the second wing between the apertures of the plurality of spray units and the trailing edge does comprise a first surface configured to exhibit a first level of adhesion to the liquid and a second surface adjacent to the first surface configured to exhibit a second level of adhesion to the liquid, and wherein the first level of adhesion is less than the second level of adhesion.

In an example, the surface of the second wing between the apertures of the plurality of spray units and the trailing edge does comprise three or more surfaces, wherein the level of adhesion alternates between the first level and second level of adhesion for adjacent surfaces progressing towards the trailing edge of the second wing.

In an example, the first level of adhesion is provided by a hydrophobic surface.

In an example, the second level of adhesion is provided by a hydrophilic surface.

In an example, the first level of adhesion is provided by a surface that is intentionally textured.

In an example, the second level of adhesion is provided by a surface that is intentionally textured.

In an example, the trailing edge of the second wing comprises teeth and/or spikes.

In an example, the trailing edge of the second wing comprises a surface that is hydrophobic.

In an example, the trailing edge of the second wing comprises a surface that is intentionally textured.

In an example, the surface of the second wing between the apertures of the plurality of spray units and the trailing edge (and preferably the first surface only) does comprise a patterned and/or structured surface, preferably grooves in the liquid atomization direction. This can facilitate the breakup of the liquid at the surface with a second level of adhesion to the liquid.

According to an example, the second wing is extendible.

In an example, the second wing is extendible via a folding mechanism.

In an example, on either side of the fore-aft axis of the UAV a first part of the second wing is configured to fold over a second part of the second wing, and the second part of the second wing is attached to a body of the UAV.

In an example, first and second parts of the second wing have associated centre axes, and wherein in an un-deployed configuration an angle between the centre axes and the fore-aft axis of the UAV is less than an angle between the centre axes and the fore-aft axis of the UAV in a deployed configuration.

In an example, in the deployed configuration the first and second parts of the second wing in the deployed configuration extend on opposite sides of the fore-aft axis of the UAV.

According to an example, spraying substantially all of the crop at a height of the wing above the crop comprises spraying a first swath and spraying a second swath in an opposite direction, wherein a region of unsprayed crop separates the first swath from the second swath.

In an example, the region of unsprayed crop has a width approximately equal to a swath width.

According to an example, spraying substantially all of the crop at a height of the wing above the crop comprises spraying a subsequent swath between the first swath and the second swath.

As would be appreciated from the above description, a UAV can be configured to carry out the above described methods.

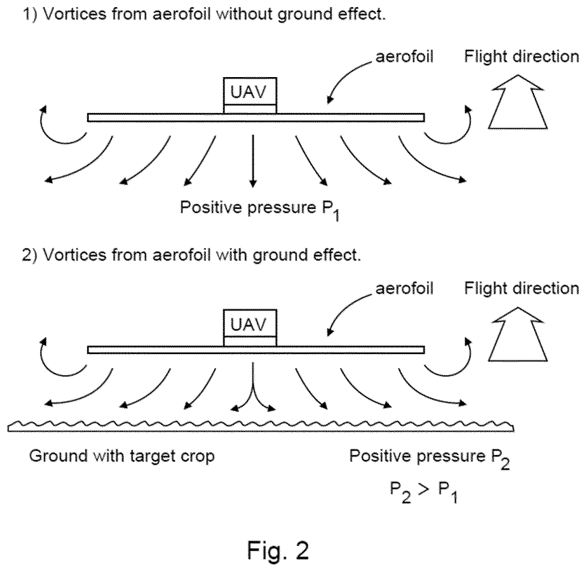

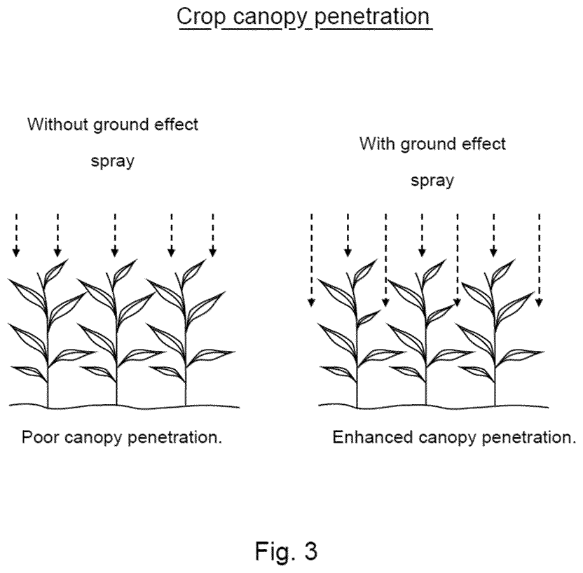

Thus, in a specific embodiment a UAV is provided with an extendible aerofoil (e.g., folding wings) and an extendible boom containing spray application devices or units (e.g., nozzles or spinning discs). The UAV is configured to fly close to crop/ground at a height less than the width of the wing, and thus the UAV makes use of what is termed the “Ground Effect” that has been utilized by military aircraft developed in Russia and the United States of America. The UAV utilizes height sensors, including forward looking height sensors that can make use of laser based sensors, GPS, accelerometers etc. in order to fly safely at a low height above the crop/ground. When sufficiently close to the ground the air underneath the aerofoil is compressed, such that during flight the aerofoil creates an area of increased pressure underneath which penetrates the crop canopy and this can be utilised to transport the spray into the canopy. This is shown schematically in FIG. 2 with respect to an existing system that is operating without the ground effect, where this existing system is shown operating with an aerofoil or wing at a height above the crop where the ground effect is not generated. This is an advantageous in that firstly it enhances penetration of the spray into the crop canopy as shown in FIG. 3, and secondly it increases the lift to drag ratio. Thus, enhanced penetration results in more effective spraying and increased lift/drag ratio reduces the power required by the UAV to remain airborne at the same time increasing the payload of spray liquid that can be carried. Furthermore, as the distance to the ground is decreased the compression increases with the consequence that these advantages increase. Benefits are that the compression can yield a wider spray swath, resulting in a higher work rate for spraying, as shown schematically in FIG. 1, where the new UAV flying at a ground effect height is shown on the left and an existing UAV flying outside of the ground effect height is shown on the right. The existing UAV could have an aerofoil or wing, as for the new UAV flying at the ground effect height but be flying at a height where the ground effect does not apply or could be a UAV with vertical lift from sets of rotor blades and again operate at a height outside of the ground effect zone.

It is to be noted that aerofoil and spray boom can mounted below the drone to give a continuous droplet generation across the whole of the aerofoil. Additionally, the aerofoil can extend beyond the spray boom to minimise off-target spray from vortices at the aerofoil tips.

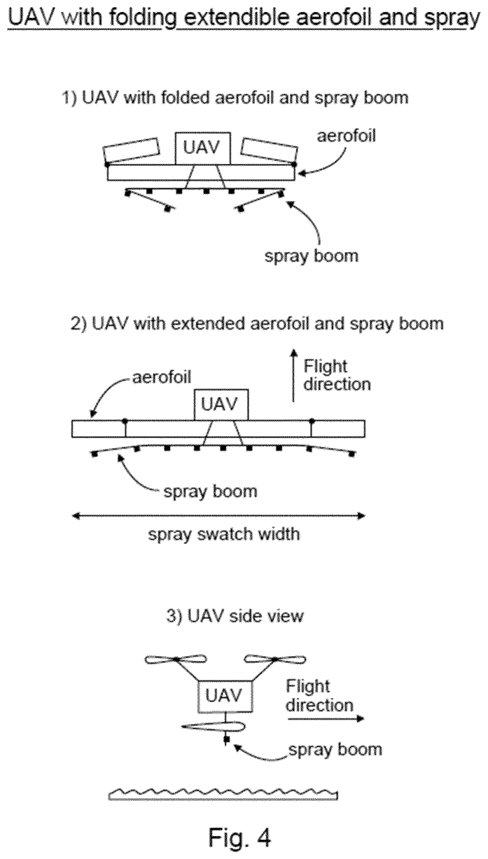

In order to keep the size of the UAV small for easy transport of the UAV and easy operator handling, extendable aerofoils and spray booms (or extendable second wings) are provided and can significantly extend the spray swath width without increasing the overall size of the UAV. This is shown schematically in FIG. 4. The benefits are that the ground effect increases as the ratio of Height/wing span decreases, therefore a UAV with extendible spray booms (or extendable second wings) and extendible wings will have an enhanced ground effect. The ground effect becomes particularly effective when the height of the UAV above the crop/ground is less than half the wing span, and this is the preferred operational height for spraying the crop, but the enhanced effects of improved spray penetration and reduced power requirements do apply up to flight heights when spraying equal to the wing span.

The UAV in a specific embodiment utilizes active aerodynamics, ailerons, flaps, leading edge slates to allow for control of the airflow into the canopy, maintaining a constant entrainment of the spray and to fly safely with a reduced stall speed that results from the ground effect.

The UAV in a specific embodiment has two sensors to measure the velocity and direction of the air relative to the air and also relative to the ground. In this way canopy penetration can remain reasonably constant at all times independent of flight direction with respect to the wind, through appropriate control of the height above the crop, as application requirements will demand a reasonably constant travel speed, with the height above the crop changing lift and penetration, and where if necessary the above described active aerodynamics can be utilized to maintain a required lift/drag ratio in order that the UAV can change the height within the ground effect zone whilst maintaining a constant flight speed. Thus, as an example the relative wind velocity can change a great deal (e.g., a 5 m/s [18 km/h] wind speed means that for an UAV flying into the wind at 20 km/h [5.6 m/s], the relative wind speed for the spray cloud is 38 km/h [10.6 m/s] whereas flying with the wind, the relative wind speed for the spray cloud is 2 km/h [0.6 m/s]. If canopy penetration is to remain reasonably constant, then as discussed the lift and crop penetration can be controlled through a variation in flight height, as application requirements can demand a reasonably constant travel speed, via adjustment of the aerodynamics of the aerofoil to give the required downforce from the ground effect.

In addition to having the aerofoil or wing to induce the ground effect when flying below a specific height, the UAV can also have a number of rotor blades facing upwards for Vertical take off and landing (VTOL), short take off and landing (STOL) and hovering. These rotors can also be used to face forwards for horizontal flight, or separate rotors can be used in for forward flight. Thus, in an example the rotors can rotate, allowing both VTOL, STOL, hovering and horizontal flight.

In flight, the ground effect compresses vortices when the height is less than the wing span. Therefore, the effect is enhanced as the height above the crop canopy decreases. The effect is also enhanced as the length and width of the aerofoil increases. Benefits are that the ground effect increases as Height/wing span decreases, so a UAV with extendible spray booms and extendible wings will have an enhanced ground effect as well as a higher work rate. An aerofoil with a wingspan of 4 m has a work rate 2× an aerofoil with a wingspan of 2 m, and an aerofoil with a wingspan of 8 m has a work rate 4× an aerofoil with a wingspan of 2 m.

A further advantage of a long wingspan is that the number of overlap regions between adjacent spray swaths is reduced. This is an advantage because the overlap regions have a risk of over or under dosing if the spray swaths are not perfectly aligned. A wingspan of 2 m has 2× the number of overlap regions of a 4 m wingspan, and 4× the number of overlap regions of an 8 m wingspan. This is shown schematically in FIG. 1, for a presently described drone on the left as opposed to a normal drone on the right that are being used to spray a field.

The ground effect has two benefits regarding penetration of the spray into the canopy, first the air flow turbulence causes movement of the plants which opens up the crop canopy, and second the positive pressure below the aerofoil pushes the spray into the canopy. Penetration into the canopy by the spray is important for an even distribution of the active ingredient(s) over the crop. This is shown in FIG. 3.

A further advantage of the aerofoil is that the ground effect increases as the flight speed increases, which also equates to an increase in the work rate, thus improving the efficiency of the application and the area that can be treated in a given time period. This is particularly effective at flight speeds greater than 20 km/h, and especially greater than 40 km/h. In this regard, the work rate at 40 km/h is 2× that at 20 km/h, and the work rate at 80 km/h is 4× that at 20 km/h.

When the benefits of wingspan and flight speed are combined, a UAV comprising an aerofoil with a wingspan of 8 m (and spray swath width of 8 m) flying at a speed of 80 km/h has a work-rate 8× that of a drone with a swath width of 4 m and a flight speed of 20 km/h.

Yet a further advantage of the ground effect is that it is self-correcting both for flight height and flight angle evenness (i.e. levelness), since if the flight height decreases the ground effect increases causing the flight height to increase, and if the flight height increases the ground effect decreases causing the flight height to decrease.

An advantage of the aerofoil is that during flight it provides lift, allowing the UAV to fly further and longer, and to carry a larger payload. This also has a benefit for the work-rate since it reduces the number of times a UAV must return to a station for refilling the spray liquid and replacing the batteries. A UAV comprising an aerofoil with a payload of 30 litres and a flight time of 60 minutes would, for the same application area, require ⅓ the number of recharging and reloading stops as a drone with a 10 litre payload and a 20 minute battery life.

In an example, the aerofoil and spray boom are mounted below the drone to give a continuous droplet generation across the whole of the aerofoil. It can be beneficial for the aerofoil to extend beyond the spray boom to minimise off-target spray from vortices at the aerofoil tips, and to ensure continuation of the ground effect at the edges of the spray swath.

A wide aerofoil has a greater risk of collision with obstacles in the field while flying. To minimise this risk, in an embodiment the UAV has stereo cameras and a processing unit to identify the location of obstacles and take avoiding action. A wide aerofoil has a greater stability for the flight height of the UAV, especially in the case of sudden gusts of wind, or in the case of air turbulence from the ground. This greater stability is a benefit since it allows the UAV to fly closer to the ground where losses due to drift are reduced, and ground effect penetration of the spray into the crop canopy is enhanced. This is particularly effective at flight heights above the canopy top less than 1.5 m, and especially effective at flight heights less than 1 m.

The lift generated by the aerofoil can be utilised to optimise the flight pattern to give turns that are efficient both in terms of battery power and time. This is illustrated in FIG. 1 and can calculated from an image of the spray fields and a suitable algorithm. Diagram (a) illustrates the optimised flight pattern for a UAV comprising an aerofoil while diagram (b) illustrates the optimised flight plan for a drone without an aerofoil. The diagrams also demonstrate the reduced number of passes required with a wider wingspan and the reduced number of overlap regions. The processing unit for this can be either on the UAV or at a base station with a high speed data connection. This can furthermore be recalculated during flight to take into account changes in the wind speed and direction.

The two velocity sensors which measure the ground speed+direction and wind speed+direction can be continuously monitored and if a high wind speed and direction relative to the ground are detected with a risk of drift, the processing unit can instruct the UAV to adjust its flight and spray parameters to reduce off-target losses. Examples of adjustable parameters include flight path, flight height, flight speed, aerofoil aerodynamics, spray droplet size and spray volume, including stopping the spray.

With a large wingspan, variations in the crop canopy density are likely, and to optimise the spray application to the target area digital imaging can be used to provide data on the canopy density and other parameters such as location, density and type of weeds, insect pests or fungal disease, and the spray from each spray device (nozzle, spinning disc or atomisation wing) can be adjusted for volume (increased, decreased or stopped) and droplet size as required. The digital imaging can be obtained directly from one or more cameras mounted on the UAV, or obtained from a separate UAV dedicated to digital imaging. The one or more cameras can be multi-spectral to aid in identification of targets.

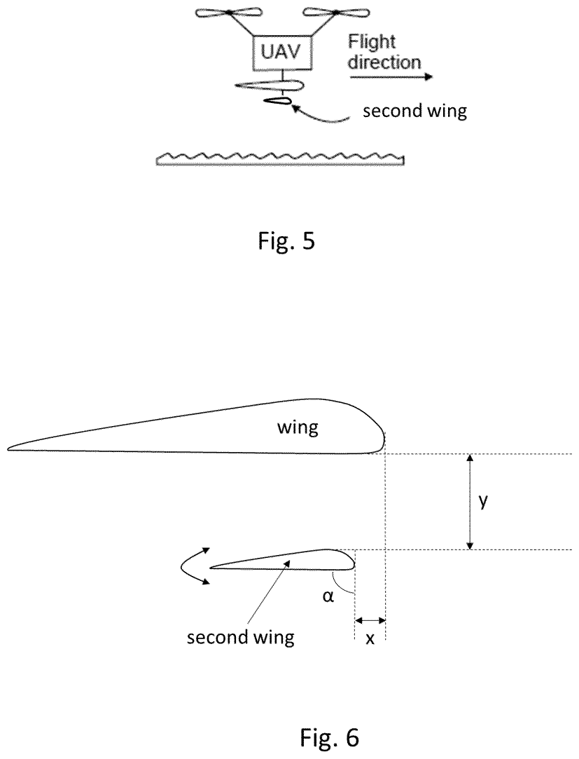

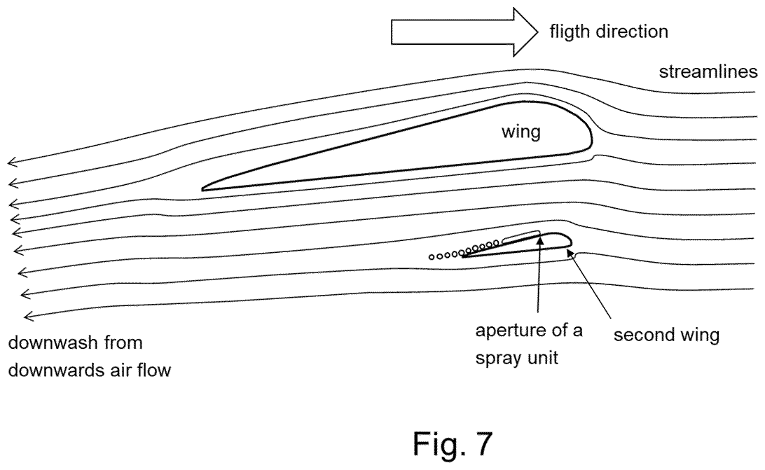

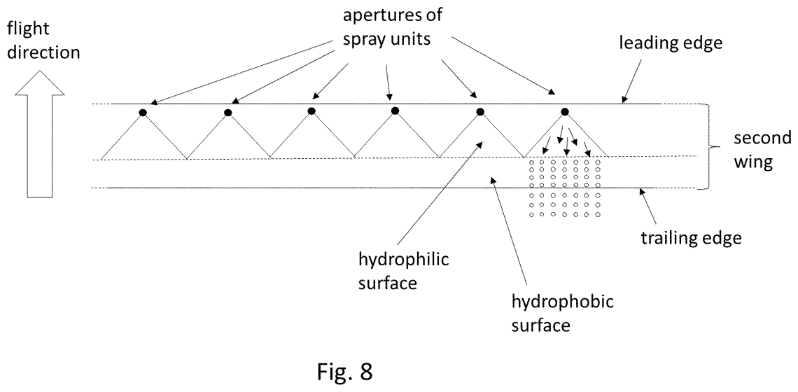

FIG. 5 shows an example of UAV with a second wing instead of a boom sprayer beneath the wing from a side view perspective. FIG. 6 indicates that the second wing is situated below the wing and the vertical (y) and horizontal (x) position, and angle (a) can be continuously adjusted to optimise the liquid atomisation process and to generate a sprayed liquid with the intended droplet size spectra. For example, by decreasing the vertical separation (y) the airflow velocity between the wing and the second wing can be increased to decrease the droplet size from the atomisation. Conversely, the droplet size can be increased by increasing the separation (y). FIG. 7 shows a schematic example of the liquid atomization process on the upper part of the second wing and the downwash from the downwards air flow of the wing and second wing from a side view perspective. FIG. 8 shows a schematic example of the second wing with a plurality of spray units from a top view perspective. Hydrophilic surfaces have high adhesion of the spray liquid and enhance spreading of the spray liquid on the surface (as indicated with arrows for the spray unit on the right side of FIG. 8), while hydrophobic surfaces have low adhesion of the spray liquid to the surface and inhibit spreading. As a consequence, the sprayed liquid beaks up into droplets when impinging on the hydrophobic surface. This is schematically illustrated in FIG. 8 for one spray unit.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

What is claimed is:

1. A method of spraying a field with an unmanned aerial vehicle (UAV), the method comprising:
flying an UAV over a crop within a field and spraying the crop with a liquid spray, wherein the UAV comprises a wing extending in directions perpendicular to a fore-aft axis of the UAV, wherein the wing has a span extending from one side of the fore-aft axis to the other side of the fore-aft axis, and wherein spraying the crop comprises spraying substantially all of the crop at a height of the wing above the crop that is less a length of the span of the wing.

2. The method according to claim 1, wherein spraying the crop with the liquid spray is carried out by a plurality of spray units extending in the directions perpendicular to the fore-aft axis of the UAV.

3. The method according to claim 2, wherein the plurality of spray units are spaced along a span equivalent to the span of the wing.

4. The method according to claim 2, wherein two spray units of the plurality of spray units are separated one from the other by a distance substantially equivalent to the length of the span.

5. The method according to claim 1, wherein the height at which substantially all of the crop is sprayed is less than half the length of the span.

6. The method according to claim 1, wherein the wing is extendible.

7. The method according to claim 6, wherein the wing is extendible via a folding mechanism.

8. The method according to claim 6, wherein on either side of the fore-aft axis of the UAV a first part of the wing is configured to fold over a second part of the wing, wherein the second part of the wing is attached to a body of the UAV.

9. The method according to claim 2, wherein the plurality of spray units are mounted on a boom separate to the wing.

10. The method according to claim 9, wherein the boom is located below a plane of the wing.

11. The method according to claim 9, wherein the boom is located in front of the wing with respect to a forward flight direction of the UAV.

12. The method according to claim 9, wherein the boom is extendible.

13. The method according to claim 2, wherein the plurality of spray units are housed within and/or attached to a second wing separate to the wing, wherein the second wing is configured to atomize the liquid from the plurality of spray units by using the airflow from the wing.

14. The method according to claim 13, wherein the second wing is located below a plane of the wing.

15. The method according to claim 13, wherein at least one plane of the second wing is located substantially parallel to at least one plane of the wing.

16. The method according to claim 13, wherein the UAV comprises at least one first actuator and at least one second actuator, wherein the at least one first actuator is configured to move the second wing in a vertical direction relative to the wing and wherein the at least one second actuator is configured to move the second wing in a horizontal direction relative to the wing, and wherein a processing unit of the UAV is configured to control the first and second actuator.

17. The method according to claim 16, wherein the UAV comprises at least one rotator actuator configured to rotate the second wing by at least one angle of rotation with respect to the horizontal axis which is perpendicular to the fore-aft axis of the UAV, wherein the processing unit is configured to control the at least one rotator actuator.

18. The method according to claim 17, wherein the UAV comprises at least one sensor configured to measure a speed of the UAV relative to the ground and at least one additional sensor configured to measure an air movement speed relative to the UAV, wherein the processing unit of the UAV is configured to determine an air movement direction relative to the ground and determine an air movement speed relative to the ground, the determination comprising utilisation of the speed of the UAV, the air movement direction relative to the UAV and the air movement speed relative to the UAV; and
wherein the processing unit of the UAV is configured to control the at least one first actuator, the at least one second actuator and/or the at least one rotator actuator; the control comprising utilisation of the determined air movement direction relative to the ground and the determined air movement speed relative to the ground.

19. The method according to claim 13, wherein the plurality of spray units are located on the upper plane of the second wing in proximity to the leading edge of the second wing.

20. The method according to claim 19, wherein the surface of the second wing between the apertures of the plurality of spray units and the trailing edge comprises a first surface configured to exhibit a first level of adhesion to the liquid and a second surface adjacent to the first surface configured to exhibit a second level of adhesion to the liquid, and wherein the first level of adhesion is less than the second level of adhesion.

21. The method according to claim 13, wherein the second wing is extendible.

22. The method according to claim 1, wherein spraying substantially all of the crop at a height of the wing above the crop comprises spraying a first swath and spraying a second swath in an opposite direction, wherein a region of unsprayed crop separates the first swath from the second swath.

23. The method according to claim 22, wherein spraying substantially all of the crop at a height of the wing above the crop comprises spraying a subsequent swath between the first swath and the second swath.

24. (canceled)

25. An unmanned aerial vehicle (UAV) for use in spraying a crop within a field with a liquid spray, the UAV comprising:
a wing extending in directions perpendicular to a fore-aft axis of the UAV, the wing having a span extending from one side of the fore-aft axis to the other side of the fore-aft axis;
wherein the UAV is configured to fly over the crop within the field and spray substantially all of the crop at a height of the wing above the crop that is less a length of the span of the wing.

26. The UAV of claim 25, further comprising a plurality of spray units extending in the directions perpendicular to the fore-aft axis of the UAV, the spray units configured to discharge the liquid spray for use in spraying the crop with the liquid spray.

27. The UAV of claim 26, further comprising a boom separate from the wing;
wherein the spray units are mounted on the boom.

28. The UAV of claim 26, further comprising a second wing separate from the wing;
wherein the spray units are housed within and/or attached to the second wing; and
wherein the second wing is configured to atomize the liquid spray discharged from the of spray units by using airflow from the wing.

29. The UAV of claim 28, further comprising:
at least one first actuator configured to move the second wing in a vertical direction relative to the wing;
at least one second actuator configured to move the second wing in a horizontal direction relative to the wing; and
at least one rotator actuator configured to rotate the second wing by at least one angle of rotation with respect to the horizontal axis which is perpendicular to the fore-aft axis of the UAV.

30. The UAV of claim 29, further comprising:
at least one sensor configured to measure a speed of the UAV relative to the ground;
at least one additional sensor configured to measure an air movement speed relative to the UAV; and
a processing unit in communication with the at least one sensor and the at least one additional sensor, the processing unit configured to:
determine an air movement direction relative to the ground and determine an air movement speed relative to the ground, the determination comprising utilisation of the speed of the UAV, the air movement direction relative to the UAV and the air movement speed relative to the UAV; and
control the at least one first actuator, the at least one second actuator and/or the at least one rotator actuator, the control comprising utilisation of the determined air movement direction relative to the ground and the determined air movement speed relative to the ground.
